(19) United States
(12) Patent Application Publication
(10) Pub. No.: US 2006/0019725 A1
(43) Pub. Date: Jan. 26, 2006

(54) Personal handphone system handset for children

(75) Inventors: Cheng-Shing Lai, Taipei Hsien (TW); Cui Qi, Nanking (CN); Yong-Cai Bian, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/893,942

(22) Filed: Jul. 20, 2004

(51) Int. Cl. H04M 1/00; H04B 1/38

(52) U.S. Cl. 455/575.1; 455/550.1

(57) ABSTRACT

The present invention discloses a personal handphone system (PHS) handset for children, which comprises a plurality of indicating lamps, a plurality of drawings corresponding to the indicating lamps, a plurality of arrow keys and an enter key for selecting the indicating lamp, a lit indicating lamp being selected by controlling the arrow keys, and a telephone number corresponding to an indicating lamp being stored in a memory of the handset, so that when a phone call is dialed from the handset by pressing the arrow keys to move the lit indicating lamp next to a drawing corresponding to the desired telephone number and pressing the enter key, a microprocessor of the handset reads the telephone number corresponding to the code of the indicating lamp from the memory and dials that telephone number directly.

### FIELD OF THE INVENTION

The present invention relates to handsets, more particularly to a personal handphone system (PHS) handset for children, allowing children to make phone calls very easily.

### BACKGROUND OF THE INVENTION

Our life has entered into a booming technological development stage for the electronic information industry. As the technologies related to various high-tech products derived from computers, mobile communication products, and telecommunication networks advance, many high-tech products and mobile communication products come with smaller sizes, more comprehensive functions, and lower prices. Such products become popular; in particularly, the popular mobile phone is closely linked to our daily life. The extensive use of mobile telecommunication products shortens the distance and the time between people. As various telecommunication products are introduced continuously into the market, people have higher demands on the functions of telecommunication products. In the future, a telecommunication product can provide a more convenient, more effective, and more diversified function or service, which is also an important index for evaluating whether or not the manufacturing technology of such telecommunication product leads others in the industry.

More and more mobile phones come with different functions such as sending or receiving short messages, connection to Internet, storing telephone numbers, setting telephone modes, editing ring tones, and installing screensavers and calculators, etc., so that users can click on their desired option among different functions as needed. However, installing too many functions in a mobile phone causes inconvenience to certain people such as children. Children usually are not familiar with the operation of a mobile phone with too complicated functions, and do not need a mobile phone with too complicated functions. Therefore, it has been a long-time goal for the telecommunication manufacturers to find a way of designing a low-cost and simple-to-use mobile phone for children.

### SUMMARY OF THE INVENTION

In view of the above description, children usually are not familiar with the operation of a mobile phone with too complicated functions and do not need a mobile phone with too complication function, the inventor of the present invention based on years of manufacturing experience and skills to conduct extensive researches, experiments, and improvements to solve the foregoing problem and finally invented a personal handphone system (PHS) handset for children in the hope of overcoming the shortcomings of the prior arts.

The primary objective of the present invention is to provide a personal handphone system (PHS) handset for children; wherein a plurality of indicating lamps and a plurality of drawings corresponding to the indicating lamps are disposed on a panel of the handset, so that each indicating lamp corresponds to a drawing; a plurality of arrow keys and an enter key are disposed on one side of the indicating lamp for selecting the indicating lamp, and a lit indicating lamp can be selected by controlling the foregoing arrow keys; a telephone number corresponding to an indicating lamp is stored in a memory of the handset, so that when a phone call is dialed from the handset by pressing the arrow keys to move the lit indicating lamp next to a drawing corresponding to the desired telephone number and pressing the enter key, a microprocessor of the handset reads the telephone number corresponding to the code of the indicating lamp from the memory and dials that telephone number. Such arrangement allows children to make phone calls very easily, and children are no longer afraid of being unfamiliar with the operation of mobile phones. In the meanwhile, the handset no longer needs to build complicated function keys on the handset or code program drivers for the complicated functions, and it thus lowers the manufacturing cost of the handset.

Another objective of the present invention is provide a personal handphone system (PHS) handset for children; wherein the enter key of the handset serves as a hang-up key for hanging up a phone call by pressing the enter key during a phone call, such that the microprocessor of the handset will disconnect a phone call according to the code of enter key.

A further objective of the present invention is to provide a personal handphone system (PHS) handset for children, wherein the enter key of the handset serves as a receive key for receiving an incoming call by pressing the enter key, so that the microprocessor of the handset receives the phone call for telephone conversations according to the code of the enter key.

The above and other objects, features and advantages of the present invention will become apparent from the following detailed description taken with the accompanying drawings.

### BRIEF DESCRIPTION OF THE DRAWINGS

FIG. 1 is a view of the appearance of the present invention.

FIG. 2 is a block diagram of the present invention.

### DETAILED DESCRIPTION OF THE PREFERRED EMBODIMENTS

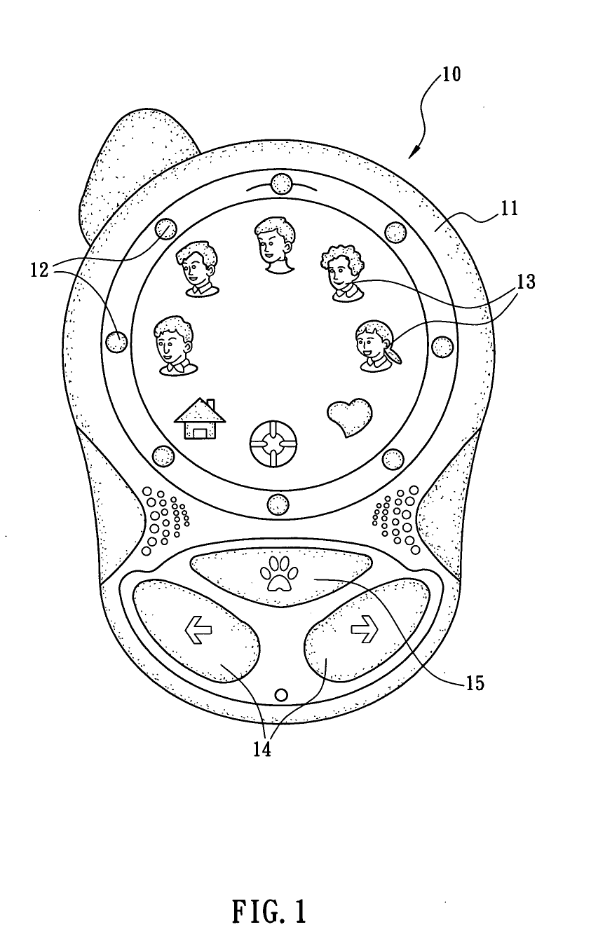

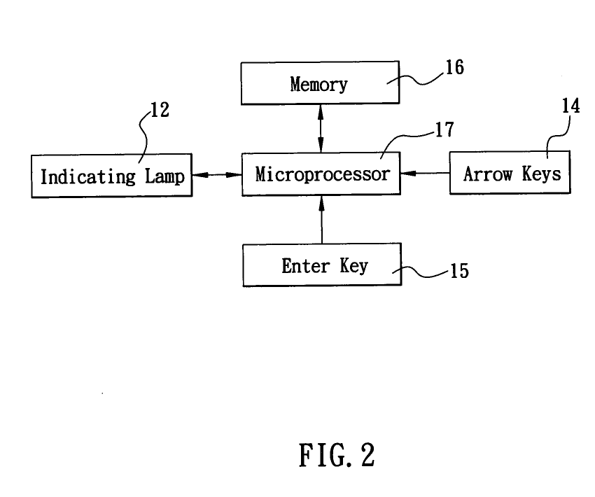

Please refer to FIG. 1 for the personal handphone system (PHS) handset for children. A plurality of indicating lamps 12 and a plurality of drawings 13 corresponding to the indicating lamps 12 are disposed on a panel 11 of the handset 10, so that each indicating lamp 12 corresponds to a drawing 13, and a plurality of arrow keys 14 is disposed on one side of the indicating lamps 12 for selecting an option. Further, only one indicating light 12 is lit at a time if the arrow keys 14 are pressed to turn on the indicating lamps 12 repeatedly one by one in a cycle. A telephone number database (as shown in FIG. 2) is stored in a memory 16 of the handset 10, and each record of telephone numbers corresponding to a code of each indicating lamp is set in the database.

Please refer to FIGS. 1 and 2 for the assembly of the foregoing components. If a call is dialed from the handset 10 by pressing the arrow keys 14 to move the lit indicating lamp 12 next to a drawing 13 corresponding to the desired calling phone number and pressing the enter key 15, the microprocessor 17 of the handset 10 will read a corresponding telephone number from the handset 10 according to the code of the lit indicating lamp 12 for dialing that telephone number.

Please refer to FIGS. 1 and 2 again. The enter key 15 of the handset 10 serves as a hang-up key, so that when a call is made from the handset 10, the enter key 15 is pressed and then the microprocessor 17 of the handset 10 hangs up the phone according to the code of the lit indicating lamp. Therefore, if it is necessary to end a telephone conversation, the enter key 1 is pressed to hang up the phone.

Please refer to FIGS. 1 and 2 again. The enter key 1 of the handset 10 serves as a receive key for receiving an incoming call, so that when a call is made to the handset 10, the enter key 15 is pressed and then the microprocessor 17 of the handset 10 receives the phone call according to the code of the enter key 15 for a telephone conversation.

Please refer to FIG. 2. The microprocessor 12 is electrically connected to the indicating lamps 12, the arrow keys 14, the enter key 15, and the memory 16 individually, so that the microprocessor 17 turns on the indicating lamps 12 one by one repeatedly in a cycle according to the signal of the arrow keys 14 and reads a corresponding telephone number from the memory 16 according to the code of the lit indicating lamp 12.

Please refer to FIG. 1 for a preferred embodiment of the present invention. Eight indicating lamps 12 and eight drawings 13 corresponding to the indicating lamps 12 are disposed on the panel 11 of the handset 10, and each indicating lamp 12 corresponds to a drawing 13, and the indicating lamps and drawings 12 are arranged in circles. Each drawing 13 is a photo of a person or an easy-to-understand drawing, so that a user can find the desired telephone call recipient easily. For example, a drawing of a house refers to the home phone number, mom's picture refers to mom's phone number, dad's picture refers to dad's phone number, grandma's picture refers to grandma's phone number, granddad's picture refers to granddad's phone number, and so forth.

Please refer to FIG. 1. A pair of arrow keys 14 (such as a left arrow key and a right arrow key) and an enter key 15 are disposed on one side of the indicating lamps 12 of the handset 10, so that the arrow keys 14 are used to control the selection of the desired lit indicating lamp 12. If the left arrow key is pressed, the indicating lamp 12 is turned on one by one towards the left side. If the right arrow key is pressed, the indicating lamp 12 is turned on one by one towards the right side. Please refer to FIG. 1 and 2. A telephone number corresponding to a code of an indicating lamp 12 is stored in the memory 16 of the handset 10, so that each record of the telephone numbers corresponds to an indicating lamp 12 and a drawing 13 respectively.

Please refer to FIGS. 1 and 2. If the handset 10 is used to dial a phone call, the arrow keys 14 are pressed to move the lit indicating lamp 12 next to the drawing 13 corresponding to the desired phone number and then the enter key 15 is pressed. The microprocessor 17 of the handset 10 reads a telephone number corresponding to the indicating lamp 12 from the memory 16 for dialing that number.

The present invention allows children to use a handset 10 very easily to make a phone call without the fear of being unfamiliar with the mobile phone operation. In the meanwhile, the handset 10 according to the present invention does not require complicated function keys or program driver with complicated functions, and thus reducing the manufacturing cost of the handset 10. Further, the handset 10 is a personal handphone system (PHS) handset, featuring a low power transmission signal and a small electromagnetic radiation, and thus will not adversely affect the user's health. Furthermore, the handset has an appearance similar to an electronic palm game to facilitate children's holding and use.

While the invention has been described by means of specific embodiments, numerous modifications and variations could be made thereto by those skilled in the art without departing from the scope and spirit of the invention set forth in the claims.

What is claimed is:

1. A personal handphone system (PHS) handset for children not familiar with the use of mobile phones, comprising:
a plurality of indicating lamps, each disposed on a panel of said handset;
a plurality of drawings, each disposed on said panel of said handset at a position corresponding to said indicating lamps, such that each of said indicating lamps respectively corresponding to each of said drawings, and a telephone number database being stored in a memory of said handset, and each telephone number record in said database corresponding to a code of said each indicating lamp; and
a plurality of arrow keys and an enter key, being disposed at a side of said indicating lamp on said panel for selecting said indicating lamps, and only one of said indicating lamps being lit at a time, such that said arrow keys are pressed to turn on said indicating lamps one by one repeatedly in a cycle;
thereby when a phone call is dialed from said handset, said arrow keys are used to move a lit indicating lamp next to one of said drawings corresponding to a desired telephone number in said telephone number database, and then said enter key is pressed, such that a microprocessor of said handset reads a code of said lit indicating lamp corresponding a telephone number from said memory for dialing said desired telephone number.

2. The personal handphone system (PHS) handset for children of claim 1, wherein said enter key of said handset serves as a hang-up key for hanging up a phone call by pressing said enter key during said phone call, so that said microprocessor of said handset disconnects said phone call according to a code of said enter key.

3. The personal handphone system (PHS) handset for children of claim 1, wherein said enter key of said handset serves a receive key for receiving an incoming call by pressing said enter key, so that said microprocessor of said handset receives said phone call according to a code of said enter key.

4. The personal handphone system (PHS) handset for children of claim 1, wherein said enter key of said each drawing is selectively a photo of a person and an easy-to-understand picture for easily finding a desired phone call recipient.
